(19) United States
(12) Patent Application Publication
(10) Pub. No.: US 2005/0114256 A1
(43) Pub. Date: May 26, 2005

(54) Method and system for settling a derivatives contract in respect of a commodity

(76) Inventors: Garry Nicholas Booth, Bellevue Hill (AU); Garry Raymond Hopper, Balmain (AU)

Correspondence Address: Ladas & Parry, 26 West 61 Street, New York, NY, 10023, US

(21) Appl. No.: 10/849,494

(22) Filed: May 19, 2004

(30) Foreign Application Priority Data
May 19, 2003 (AU) 2003902419

(51) Int. Cl. G06F 17/60

(52) U.S. Cl. 705/37

(57) ABSTRACT

A method of settling a derivatives contract in respect of a commodity, the method comprising the steps of:
receiving 501 a tender request form indicating that an amount of the commodity, which has been credited to a clearinghouse that is responsible for managing settlement of the derivatives contract, is to be tendered;
selecting 509 a long position to take delivery of the amount of the commodity; and effecting delivery of the amount of the commodity to fulfil the long position, thereby settling the derivatives contract.

### FIELD OF THE INVENTION

The present invention relates to a method and system for settling a derivatives contract in respect of a commodity, and has particular—but by no means exclusive—application to settling a futures contract for grain.

### BACKGROUND OF THE INVENTION

A derivatives contract, such as a futures contract, is a legally binding agreement between two parties to buy or sell a particular commodity on a specified date in the future. Derivatives contracts are traded over a wide range of commodities such as gold, grain, base metals and electricity.

Derivatives contracts are commonly made via exchanges, such as the Australian Stock Exchange (ASX). The ASX, for instance, has an electronic derivatives trading platform that allows parties to enter into a derivatives contract. The ASX's derivatives trading platform is also known as CLICK™. Once a derivatives contract has been established, it is sometimes registered with a clearinghouse that is essentially responsible for the orderly settlement of derivatives contracts on maturity; that is, ensuring the commodity is delivered to the purchaser and that the purchaser pays for the delivered commodity.

### SUMMARY OF THE INVENTION

According to a first aspect of the present invention, there is provided a method of settling a derivatives contract in respect of a commodity, the method comprising the steps of:
receiving a tender request form indicating that an amount of the commodity, which has been credited to a clearinghouse that is responsible for managing settlement of the derivatives contract, is to be tendered;
selecting a long position to take delivery of the amount of the commodity; and
effecting delivery of the amount of the commodity to fulfil the long position, thereby settling the derivatives contract.

Thus, the present invention has an advantage of maintaining confidentiality of trader's positions by virtue of the fact that it is dealing with a commodity that has been credited to the clearinghouse.

Preferably the step of receiving the tender request form comprises the step of receiving the tender request form from a first broker acting on behalf of an entity that has an interest in the amount of the commodity.

Preferably the step of selecting the long position comprises the step of randomly selecting the long position from one or more open bought contracts.

Preferably the step of effecting delivery of the amount of the commodity comprises the steps of:
issuing a second broker responsible for establishing the long position with a delivery notice comprising information about the amount of the commodity;
receiving from the second broker a payment for the amount of the commodity; and
making a further payment to the first broker for the amount of the commodity.

Preferably the method further comprises the step of receiving from the first broker a title transfer notice that represents a request to have the amount of the commodity credited to the clearinghouse.

Preferably, the method further comprises the step of receiving a confirmation notice confirming that the amount of the commodity has been credited to the clearinghouse.

Preferably, the step of obtaining the confirmation notice comprises the step of receiving the confirmation notice from a storage facility responsible for storing the amount of the commodity.

Preferably, the derivatives contract comprises a futures contract.

Preferably, the commodity comprises a grain.

According to a second aspect of the present invention, there is provided a system for settling a derivatives contract in respect of a commodity, the system comprising:
an electronic document exchange device operable to receive a tender request form indicating that an amount of the commodity, which has been credited to a clearinghouse that is responsible for managing settlement of the derivatives contract, is to be tendered;
a computer system operable to select a long position to take delivery of the amount of the commodity; and
an electronic communication means operable to effect delivery of the amount of the commodity to fulfil the long position, thereby settling the derivatives contract.

Preferably, the electronic document exchange device is operable to receive the tender request form from a first broker acting on behalf of an entity that has an interest in the amount of the commodity.

Preferably, the computer system is operable to select the long position from one or more open bought contracts.

Preferably, the electronic communication means comprises another electronic document exchange device operable to:
issue a second broker responsible for the long position with a delivery notice comprising information about the amount of the commodity;
receive from the second broker a payment for the amount of the commodity; and
make a further payment to the first broker for the amount of the commodity.

Preferably, the electronic document exchange device is operable to receive from the first broker a title transfer notice that was issued as a request to have the amount of the commodity credited to the clearinghouse.

Preferably, the electronic document exchange device is operable to receive a confirmation notice confirming that the amount of the commodity has been credited to the clearinghouse.

Preferably, the electronic document exchange device is operable to receive the conformation notice from a storage facility responsible for storing the amount of the commodity.

Preferably, the derivatives contract comprises a futures contract.

Preferably, the commodity comprises a grain.

According to a third aspect of the present invention, there is provided a computer software which, when run as a computing system, allows the computing system to carry out the method according to the first aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 provides a screen shot of information presented on a computer terminal used in conjunction with a derivatives trading platform;

FIG. 2 provides a schematic diagram of a system used to settle a derivatives contract;

FIG. 3 shows an example of a title transfer form that is used in settling a derivatives contract;

FIG. 4 shows an example of a tender request form used in settling a derivatives contract;

FIG. 5 provides a flow chart of various steps used to settle a derivatives contract;

FIG. 6 shows an example of a delivery notice used in settling a derivatives contract; and

FIG. 7 shows an example of a redemption notice used to settle a derivatives contract.

### AN EMBODIMENT OF THE PRESENT INVENTION

The embodiment of the present invention has particular application to the settlement phase of a futures contract in respect of an amount of a grain (for example, milling wheat, barley or canola). Thus the following description focuses on a seller, in legal possession of an amount of grain, opening a futures position by entering into a futures contract to sell the amount of the grain.

When the seller wishes to open the futures position they first instruct a broker (also referred to as a trading participant) that they would like to sell the amount of the grain. The seller will typically instruct the broker via telephone or facsimile. It will, however, be appreciated that other forms of electronic communication can be used to convey the instruction to sell the amount of the grain; for example, e-mail or via a website operated by the broker. As part of the instructions to the broker the seller will specify details such as the type of the grain (for example, whether it is barley or canola), the amount of the grain, the price the seller is asking for the amount of the grain, and the particular date in the future which the seller wants to sell the amount of the grain.

On receiving the instructions to sell the amount of the grain, the broker proceeds to list the seller's offer to sell the amount of grain on an electronic derivatives trading platform that is operating by a stock exchange. The broker lists the seller's offer by entering into the trading platform details such as, the type of grain the seller wants to sell, the price the seller is asking for the grain, and the particular date on which the seller wants to sell the grain.

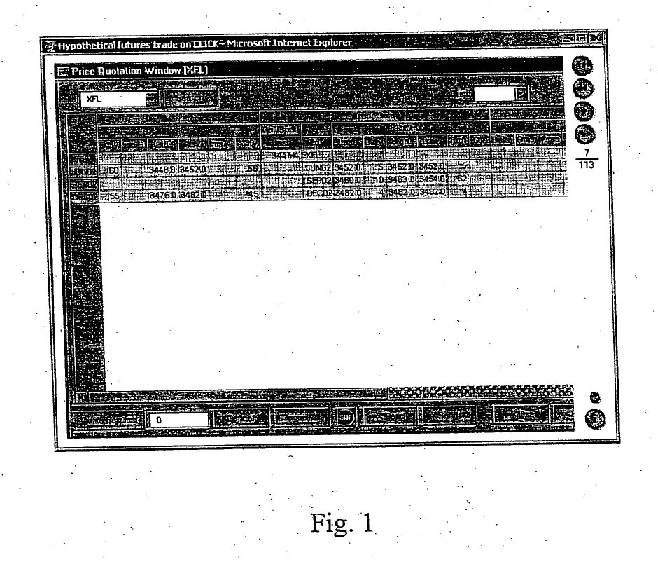

The electronic derivatives trading platform comprises a central computer system that is under the control of the stock exchange and which is based on the well known CLICK™ system from OM AB. Connected to the central computer system is a number of computer terminals. The computer terminals are generally located in the offices of futures brokers, and enable the brokers to view and make offers to buy and/or sell the grain via the central computer system. It is noted that the terminals can also be used to view offers to buy and/or sell other commodities such as electricity. The each computer terminal is connected to the central computer system via a secure digital communication link, which is typically supported by ISDN technology. The broker acting on behalf of the seller uses the computer terminal in their office to list the seller's offer to sell the amount of the grain on the electronic derivates trading platform. The central computer system of the trading platform is such that it disseminates to all of the computer terminals the seller's offer to sell the amount of the grain so that other brokers are capable of seeing the seller's offer. Thus, other brokers viewing a computer terminal can opt to take-up the seller's offer. FIG. 1 shows an example screen shot of information (offers to buy and/or sell the grain) presented to the brokers via the computer terminals.

The electronic derivatives trading platform (more specifically the central computer system) is such that it will automatically match the seller's offer to sell the amount of the grain with a corresponding offer to buy the grain. The offer to buy the amount of the grain is also listed on the trading platform by another broker acting on behalf of a buyer wanting the amount of the grain. The offer to buy the amount of the grain is made in the same way as the seller's offer to sell the amount of the grain, which is by entering the offer into the trading platform using one of the computer terminals.

Once the offer to sell is matched with the offer to buy, a futures contract is effectively established in respect of the amount of the grain. The electronic derivatives trading platform is arranged to electronically transfer details of the futures contract to a clearinghouse so that it can be recorded and registered. The clearinghouse is essentially responsible to ensuring orderly settlement of the futures contract. An example of the clearinghouse is the Australian Clearing House Pty Ltd, which is a wholly owned subsidiary of the Australian Stock Exchange. To ensure the seller and the buyer are not exposed to the credit risk of each other, the clearinghouse uses the concept of novation. This basically means that the clearinghouse becomes the buyer to the seller, and the seller to the buyer.

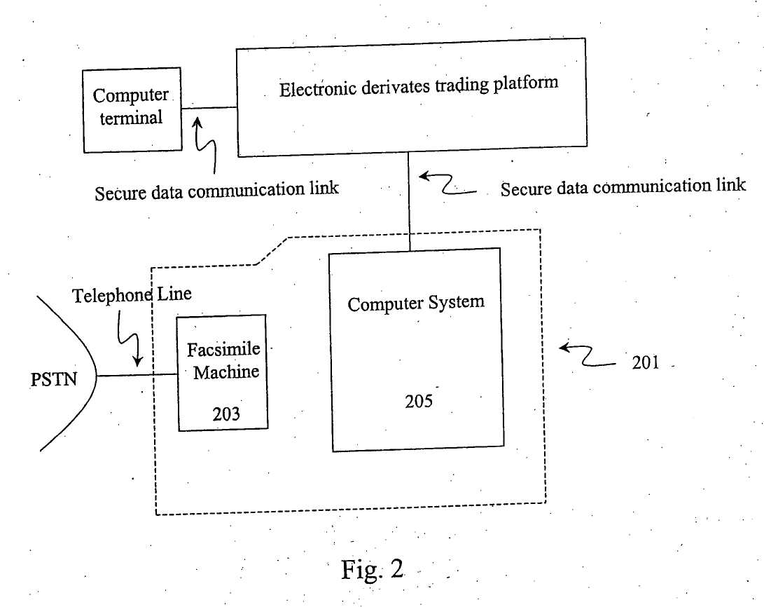

The clearinghouse operates a system 201, which it uses to settle the futures contract received from the electronic derivatives trading platform. The system 201, which is shown in FIG. 2, comprises: a first electronic document exchange device and an electronic communication means that comprise a facsimile machine 203 that is connected to a public telephone network; and a computer system 205 in the form of a computer running appropriate database software. It is noted that whilst in the present embodiment the electronic document exchange device and the electronic communication means comprise the facsimile machine 203, it will be readily appreciated that other means for transferring an electronic copy of a document could be used. Once such alternative is the user sending a copy of the document via e-mail or submitting it to a website operated by the clearinghouse.

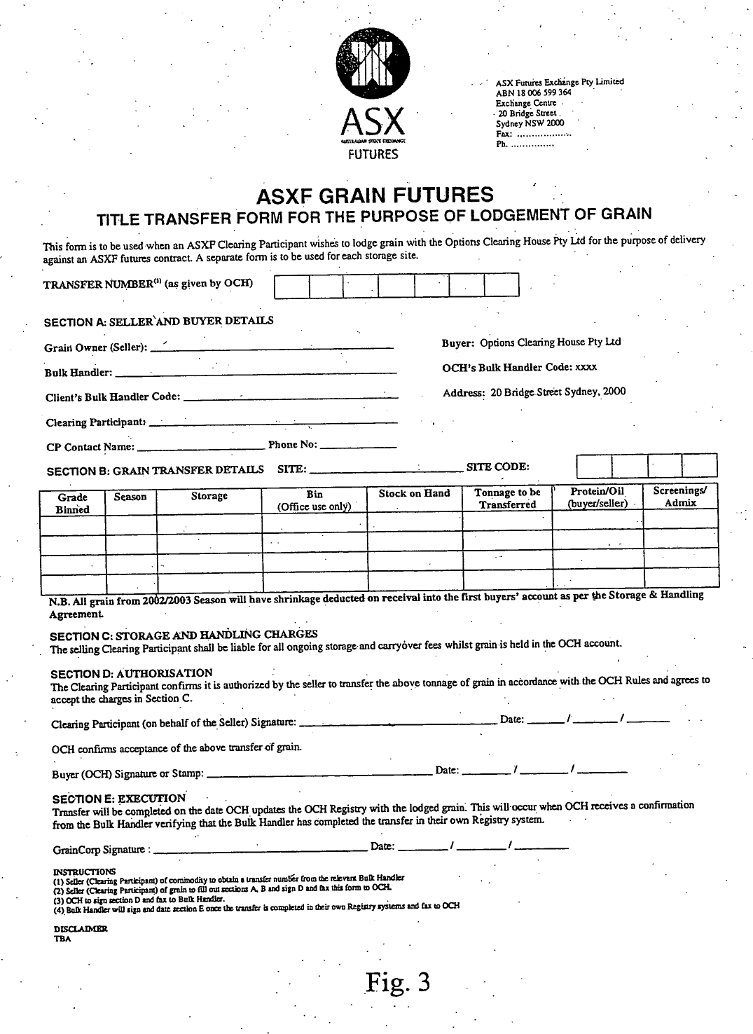

Upon deciding to tender (deliver) the amount of the grain against the futures contract. The seller will at a given date before the maturity date of the futures contract advise the broker of their intention to tender the amount of the grain to fulfil the futures contract. The seller typically informs the broker of this intention by placing a telephone call or facsimile. On being advised that the seller wants to tender the amount of the grain the broker completes a title transfer form and sends it via facsimile to a grain handler that is storing the amount of the grain for the seller. The broker also faxes a copy of the title transfer form to the facsimile machine 203 so that the clearinghouse is aware that the title transfer form has been filed. An example of the title transfer form is shown in FIG. 3. Essentially, the title transfer form represents a request by the seller to have the amount of the grain transferred from a first account that the seller has with the grain handler to a second account that the clearinghouse has with the grain handler.

Subsequent to receiving the title transfer form, the grain handler will first check the seller's account to determine whether it is storing for the seller the grain that is specified in the title transfer form. On determining that it is storing the grain, the grain handler updates its records so that the clearinghouse's account is credited with the grain specified in the title transfer and the seller's account is debited the grain specified in the title transfer form. The grain handler will typically update the first account and the second account by using a computer based inventory record system.

Once the seller's account and the clearinghouse's account has been updated, the grain handler faxes to the clearinghouse a notice of the fact that the clearinghouse's account has been credited with the grain specified in the title transfer form. The grain handler. Fixes the notice to the facsimile machine 203 so that the clearinghouse is aware of this matter.

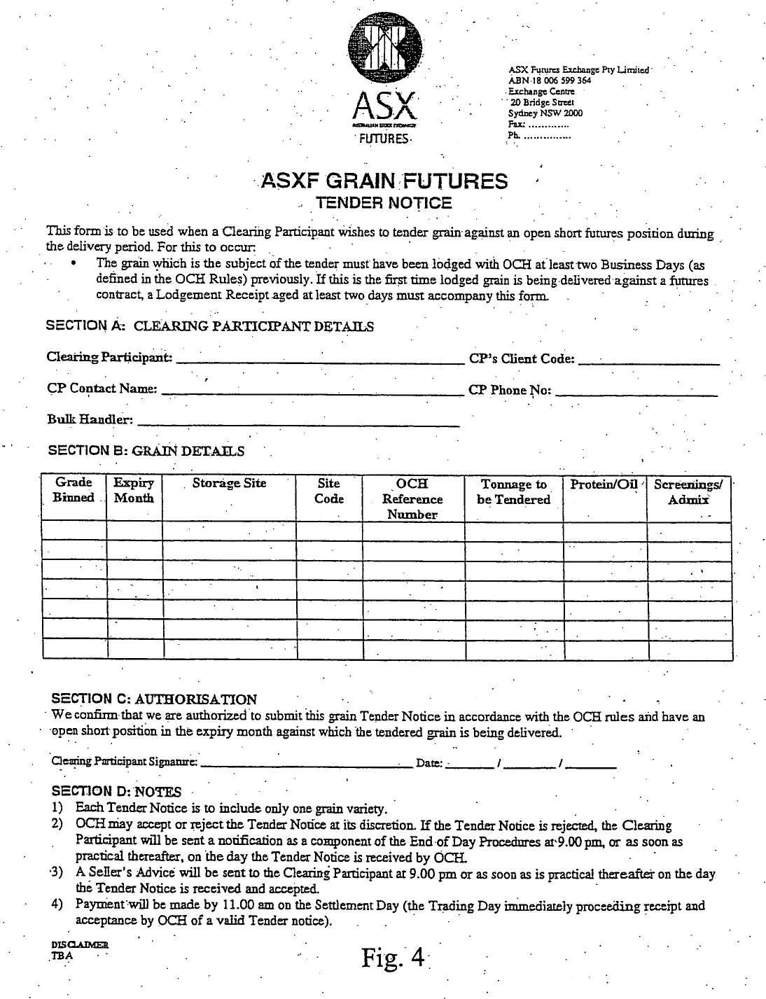

Once the amount of the grain has been credited to the clearinghouse's account with the grain handler, the seller can at the appropriate time before the futures contract matures instruct the broker to initiate tendering of the amount of the grain that was previously credited to the clearinghouse's account. In this regard, the seller typically instructs the broker by making a telephone call or facsimile; however, it will be appreciated that communication mechanisms such as e-mail can be used to instruct the broker in this regard. On receiving an instruction to tender the amount of the grain the broker proceeds to complete a tender request form and sends it to the clearinghouse as a facsimile to the facsimile machine 203. An example of the tender request form is shown in FIG. 4.

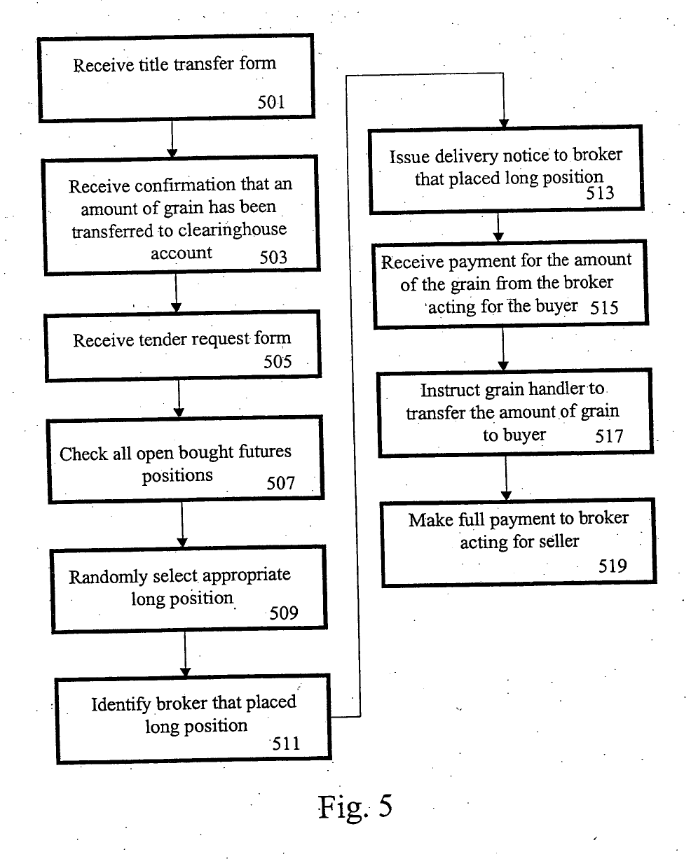

On receiving the tender request form from the broker, the clearinghouse proceeds to settle the futures contract by carrying out the various steps shown in the flow chart of FIG. 5. As such the clearinghouse carries out the step 507 of checking all open bought futures positions that have not been matched out, and then proceeds to carry out the step 509 of randomly selecting an appropriate long position to take delivery of the amount of the grain. Persons skilled in the art will readily appreciate that a long position is when a trader has purchased a futures contract and is committed to take ownership of the amount of the grain.

The previous steps 507 and 509 are performed by using the computer system 205. It is noted that when the offers to buy and sell the amount of the grain (futures contracts) are transferred from the electronic derivatives trading platform to the clearinghouse, details of the offers to buy and sell are loaded into the computer system 205 so that the previous steps 507 and 509 can be carried out. The computer system 205 is such that it can receive, in electronic form, details of the futures contracts via a secure communication link which interconnects the derivatives trading platform and the computer system 205.

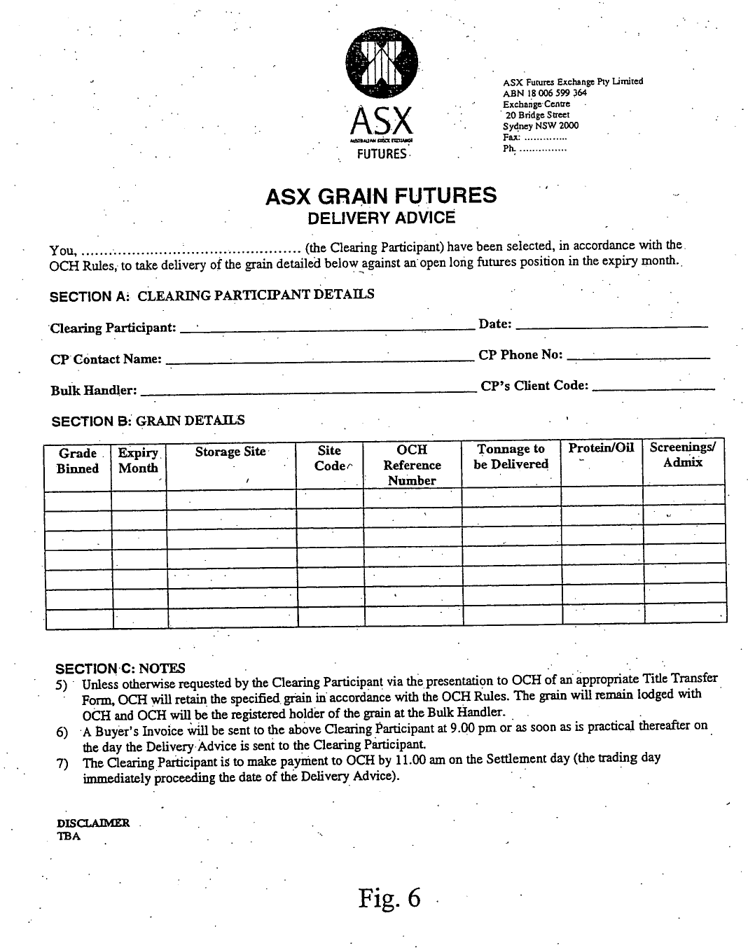

Using the information contained in the computer system 205, the clearinghouse carries out the next step 511 of identifying the broker responsible for establishing the long position; that is the broker that listed the buyer's offer to buy the amount of the grain. It is noted that details of the buyer's broker are transferred to the computer system 205 from the derivatives trading platform along with the details of the offers to buy and sell the amount of the grain. Using the facsimile machine 203, the clearinghouse carries out the step 513 of faxing a delivery notice to the broker responsible for listing the buyer's offer. The delivery notice basically sets out details of the amount of the grain that is being tendered. An example of the delivery notice is shown in FIG. 6.

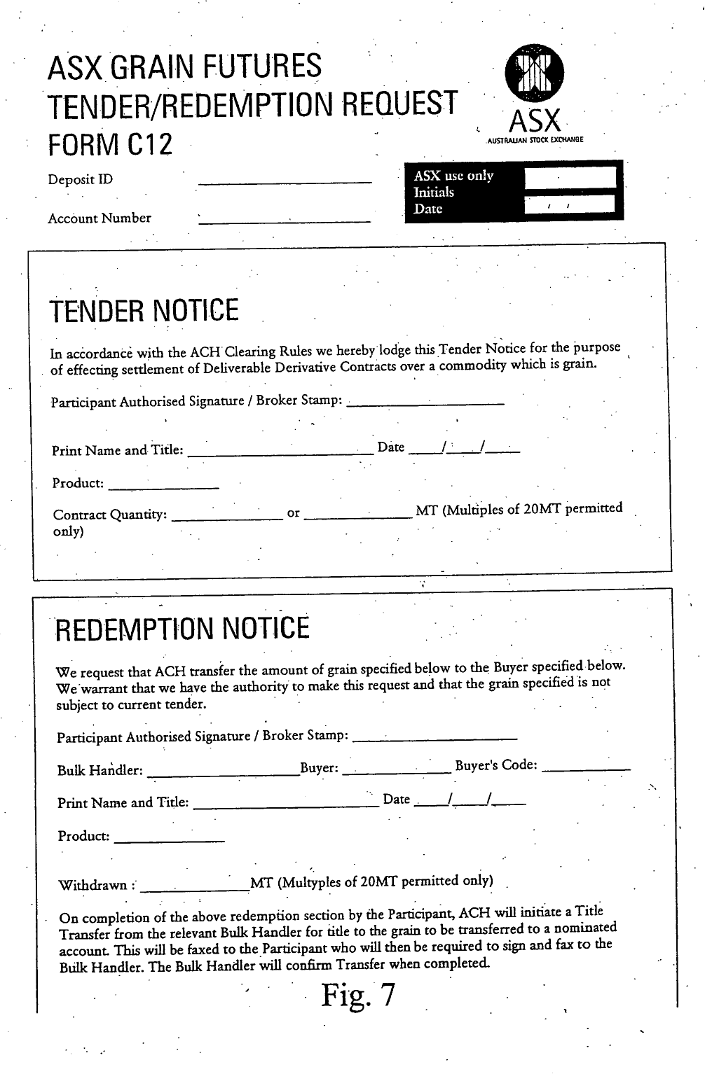

On receiving the delivery notice from the clearinghouse, the buyer's broker arranges to make full payment to the clearinghouse for the amount of grain that is being tendered. Typically, the buyer's broker will make the full payment by way of an electronic bank transfer to the clearinghouse's bank account. On receiving the full payment and a redemption notice (which is shown in FIG. 7) from the buyer's broker, the clearinghouse carries out the step 517 of instructing the grain handler to transfer the amount of the grain from the clearinghouse's account to the buyer's account with the grain holder. Typically the grain holder carries out this step 517 by sending a facsimile to the grain holder using the facsimile machine 203. The clearinghouse then performs the final step 519 of arranging for the full payment to be transferred to the broker acting for the seller of the amount of the grain. Typically, this payment is also made using an electronic bank transfer to the seller's broker. The seller's broker will in turn pass on the payment to the seller, thereby settling delivery of the amount of the grain. If the clearinghouse does not receive the redemption notice, then the clearinghouse will not carry out the step 517 of instructing the grain handler. Consequently, the amount of the grain will remain in the clearinghouse's account until such time as the redemption notice is received.

It is noted that whilst the embodiment of the present invention has been described in the context of a futures contract for grain, the present invention has a broader application to other derivatives contracts, such as options, and other commodities, such as wool.

Those skilled in the art will appreciate that the invention described herein is susceptible to variations and modifications other than those specifically described. It should be understood that the invention includes all such variations and modifications which fall within the spirit and scope of the invention.

1. A method of settling a derivatives contract in respect of a commodity, the method comprising the steps of:
receiving a tender request form indicating that an amount of the commodity, which has been credited to a clearinghouse that is responsible for managing settlement of the derivatives contract, is to be tendered;
selecting a long position to take delivery of the amount of the commodity; and
effecting delivery of the amount of the commodity to fulfil the long position, thereby settling the derivatives contract.

2. The method as claimed in claim 1, wherein the step of receiving the notice comprises the step of receiving the tender request form from a first broker acting on behalf of an entity that has an interest in the amount of the commodity.

3. The method as claimed in claim 1, wherein the step of selecting the long position comprises the step of selecting the long position from one or more open bought contracts.

4. The method as claimed in claim 1, wherein the step of effecting delivery of the amount of the commodity comprises the steps of:
issuing a second broker responsible for the long position with a delivery notice comprising information about the amount of the commodity;
receiving from the second broker a payment for the amount of the commodity, and
making a further payment to the first broker for the amount of the commodity.

5. The method as claimed in claim 2, further comprising the step of receiving from the first broker a title transfer notice that represents a request to have the amount of the commodity credited to the clearinghouse.

6. The method as claimed in claim 1, further comprising the step of receiving a confirmation notice confirming that the amount of the commodity has been credited to the clearinghouse.

7. The method as claimed in claim 6, wherein in the step of receiving the confirmation notice comprises the step of receiving the conformation notice from a storage facility responsible for storing the amount of the commodity.

8. The method as claimed in claim 1, wherein the derivatives contract comprises a futures contract.

9. The method as claimed in claim 1, wherein the commodity comprises a gram.

10. A system for settling a derivatives contract in respect of a commodity, the system comprising:
an electronic document exchange device operable to receive a tender request form indicating that an amount of the commodity, which has been credited to a clearinghouse that is responsible for managing settlement of the derivatives contract, is to be tendered;
a computer system operable to select a long position to take delivery of the amount of the commodity; and
an electronic communication means operable to effect delivery of the amount of the commodity to fulfil the long position, thereby settling the derivatives contract.

11. The system as claimed in claim 10, wherein the electronic document exchange device is operable to receive the tender request form from a first broker acting on behalf of an entity that has an interest in the amount of the commodity.

12. The system as claimed in claim 10, wherein the computer system is operable to select the long position from one or more open bought contracts.

13. The system as claimed in claim 10, wherein the electronic communication means comprises another electronic document exchange device operable to: issue a second broker responsible for the long position with a delivery notice comprising information about the amount of the commodity;
receive from the second broker a payment for the amount of the commodity; and
make a further payment to the first broker for the amount of the commodity.

14. The system as claimed in claim 11, wherein the electronic document exchange device is operable to receive from the first broker a title transfer notice that was issued as a request to have the amount of the commodity credited to the clearinghouse.

15. The system as claimed in claim 10, wherein the electronic document exchange device is operable to receive a confirmation notice confirming that the amount of the commodity has been credited to the clearinghouse.

16. The system as claimed in claim 15, wherein the electronic document exchange device is operable to receive the conformation notice from a storage facility responsible for storing the amount of the commodity.

17. The system as claimed in claim 10, wherein the derivatives contract comprises a futures contract.

18. The system as claimed in claim 10, wherein the commodity comprises a gram.

19. Computer software which, when run on a computing system, allows the computing system to carry out the method as claimed in claim 1.

20. (canceled).

21. (canceled).
